(19) United States
(12) Patent Application Publication
(10) Pub. No.: US 2014/0032364 A1
(43) Pub. Date: Jan. 30, 2014

(54) SYSTEM AND METHOD FOR PROVIDING VERIFICATION OF SELLER AUTHORIZATION AND PRODUCT AUTHENTICATION

(71) Applicant: Wesley K. Shepherd, Chicago, IL (US)

(72) Inventor: Wesley K. Shepherd, Chicago, IL (US)

(73) Assignee: OnRamp Technologies, LLC, Chicago, IL (US)

(21) Appl. No.: 13/951,427

(22) Filed: Jul. 25, 2013

Related U.S. Application Data
(60) Provisional application No. 61/675,411, filed on Jul. 25, 2012.

(51) Int. Cl. G06Q 30/06

(52) U.S. Cl. CPC G06Q 30/0609
USPC 705/26.35

(57) ABSTRACT

A system. The system includes a computing device, a verification module and a badging module. The computing device includes a processor. The verification module is communicably connected to the processor and is configured to determine if the seller has an account with the system and if the seller is authorized by a manufacturer to sell a product manufactured by the manufacturer and being offered for sale on a product web page. The badging module is communicably connected to the processor and is configured to generate a badge if the seller has an account with the system and the seller is authorized by the manufacturer to sell the product.

### CROSS-REFERENCE TO RELATED APPLICATION

This application claims the benefit under 35 U.S.C. §119(e) of the earlier filing date of U.S. Provisional Patent Application No. 61/675,411 filed on Jul. 25, 2012.

### BACKGROUND

This application discloses an invention which is related, generally and in various embodiments, to a system and method for providing verification of seller authorization and product authentication.

Manufacturers go to great lengths to identify, train and educate retailers, dealers, etc. who the manufacturers believe will be able to provide excellent service to consumers and purchasers of their products before, during and after a sale. Many manufacturers have created tremendous amounts of goodwill for their companies and their products, and rely on authorized sellers (e.g., retailers, dealers, etc.) to maintain and contribute to that goodwill by interacting with the end consumer in a manner desired by the manufacturers. To encourage people to purchase products from authorized sellers, many manufactures take actions such as limiting rebates to products sold only by authorized sellers, voiding warranties on products sold by unauthorized sellers, and reimbursing authorized dealers for marketing activities.

As more and more products are being sold online, it is becoming increasingly difficult to determine who is and who is not authorized by the manufacturer to sell a given product. To compound these problems, with each passing year, increasing numbers of fake goods as well as gray market goods (items made for one geographic market and imported into another geographic market) are being sold to unsuspecting consumers. Legitimate online retailers are well aware of these problems and many have been attempting to work with product manufacturers to curtail these issues. Some online retailers utilize watermarks, seals or other graphics that indicate they are an authorized dealer on web pages to represent that they are authorized by individual manufacturers to sell the products included on the web page. Although some of these representations are accurate, many are not. There are many unauthorized sellers who simply cut and paste or generate copies of these graphics then include the graphic on their web page even if they are not an authorized seller. Because every representation of an authorized dealer badge so far has been a static graphic, copying has been very easy to perform and the copied graphic has been indistinguishable from the original. Some unauthorized sellers simply lay claim with text or graphics that they are authorized for various manufacturers. Unfortunately, the consumers viewing all of the text and graphics currently being used have no real idea whether the assertions being made by the sellers are truthful. Because there are currently no trusted third parties to verify the claimed relationships, consumers can not easily distinguish the legitimate authorized sellers from the ones who are being dishonest.

As a result of this consumer uncertainty, manufacturers are failing to increase the confidence of online purchasers, failing to drive increased sales through their authorized sellers, and failing to adequately manage the goodwill associated with their products and brands. Similarly, the authorized sellers are also failing to increase the confidence of their online customers, failing to establish online shopping norms, failing to drive increased purchases from their customers, and contributing less to the goodwill associated with the products they sell than desired.

### BRIEF DESCRIPTION OF THE DRAWINGS

Various embodiments of the invention are described herein in by way of example in conjunction with the following figures, wherein like reference characters designate the same or similar elements.

FIG. 1 illustrates various embodiments of a system;

FIG. 2 illustrates various embodiments of a computing system of the system of FIG. 1;

FIGS. 3-6 are exemplary screen shots of badges, endorsements and certificates provided by the system of FIG. 1;

FIG. 7 illustrates various embodiments of a method; and

FIGS. 8-16 are additional exemplary screen shots provided by the system of FIG.

### DETAILED DESCRIPTION

It is to be understood that at least some of the figures and descriptions of the invention have been simplified to illustrate elements that are relevant for a clear understanding of the invention, while eliminating, for purposes of clarity, other elements that those of ordinary skill in the art will appreciate may also comprise a portion of the invention. However, because such elements are well known in the art, and because they do not facilitate a better understanding of the invention, a description of such elements is not provided herein.

As described in more detail hereinbelow, aspects of the invention may be implemented by a computing device and/or a computer program stored on a computer-readable medium. The computer-readable medium may comprise a disk, a device, and/or a propagated signal.

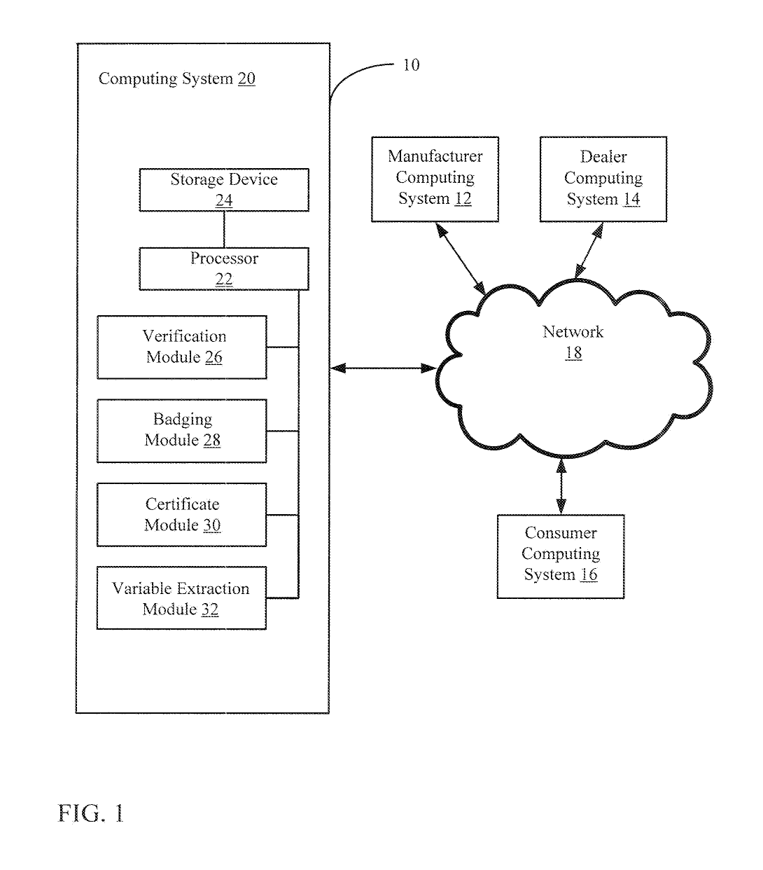

FIG. 1 illustrates various embodiments of a system 10. As shown in FIG. 1, the system 10 may be communicably connected to a manufacturer computing system 12, a dealer/retailer computing system 14 and a consumer computing system 16 via one or more networks 18. As the manufacturer computing system 12 and the dealer computing system 14 are communicably connected to the network 18, it will be appreciated that manufacturer computing system 12 and the dealer computing system 14 may be communicably connected to one another via the network 18. Similarly, since the dealer computing system 14 and the consumer computing system 16 can each be communicably connected to the network 18, it will be appreciated that the dealer computing system 14 and the consumer computing system 16 may be communicably connected to one another via the network 18. Although only one manufacturer computing system 12, one dealer/retailer computing system 14 and one consumer computing system 16 are shown as being communicably connected to the system 10, it will be appreciated that any number of manufacturer's computing systems 12, dealer's/retailer's computing systems 14 and consumer's computing systems 16 may be communicably connected to the system 10.

As explained in more detail hereinbelow, the system 10 may be utilized to provide verification to a consumer that an online seller (e.g., a dealer/retailer) of a product (i.e., a good or service) is authorized by the manufacturer to sell the product and that the product is an authentic product (e.g., made by the manufacturer). Since the verification provided by the system 10 is based on information provided by the product manufacturer and the seller of the product (and/or information retrieved from the manufacturer computing system 14 and the dealer computing system 14), the verification may be considered a mutual verification of a trusted business relationship, of product authenticity and authorized dealer/retailer status. As used herein, the term “product” is meant to include goods and/or services.

The manufacturer computing system 12 may include any suitable type of computing device. For example, according to various embodiments, the manufacturer computing system 12 may include one or more servers, desktops, laptops, etc. which can be communicably connected to the network 18. The manufacturer associated with the manufacturer computing system 12 may utilize the manufacturer computing system 12 to create an account with the system 10 and to thereafter provide the system 10 with information regarding its authorized dealers, including business rules applicable to the authorized dealers. Such business rules may include, for example, the following variables: which product lines/brands they are authorized to sell, the stock-keeping units (SKUs) of the products they are authorized to sell, which geographic territories they are authorized to sell in, warranty information regarding the products, specific manufacturer/dealer relationship information, uniform resource locators (URLs) for approved products, brands, model/style numbers, etc. According to various embodiments, prior to providing the information regarding its authorized dealers, the manufacturer computing system 12 may first access the system 10 to search for matching retailers/dealers with their currently authorized dealers. A manufacturer may also utilize the manufacturer computing system 12 to manually add a retailer to the system 10 to complete their coverage of all online retailers.

The parameters applied to the manufacturers business rules may also be extracted or received from retailers by the system 10. A given retailer can send a plurality of values for every one of the aforementioned variables listed but it is certain that some values will not match up against those in the manufacturer's business rules even though they should (e.g., Sony vs. Sony Corp.). A manufacturer can alias (translate an unmatched variable that is in fact a matching variable to the one the manufacturer entered) unmatched values they have sent to the system 10 or that the system 10 has extracted. According to various embodiments, the system 10 may automatically retrieve the information regarding the variables from the manufacturer computing system 12.

Using the manufacturer computing system 12, a manufacturer will be able to view network statistics generated via the variables and values they have sent via the software application (e.g., javascript) on the retailers web pages. Additionally, web logs resident on the system 10 and generated via the traffic to these pages will provide various data such as time visited, referring URL to the badge, operating system, browser, time spent on page, IP address, etc. The combination of both sets of data will generate relevant traffic statistics around the SKU, brand, retailer site, category, model, URL, etc.

The dealer computing system 14 may include any suitable type of computing device. For example, according to various embodiments, the dealer computing system 14 may include one or more servers, desktops, laptops, etc. which can be communicably connected to the network 18. The dealer/retailer associated with the dealer computing system 14 may utilize the dealer computing system 14 to create an account with the system 10 and to thereafter provide the system 10 with information regarding the manufacturers for which the dealer/retailer is an authorized dealer. The retailer can also invite a manufacturer not having an account with the system 10 to authorize their online sales as well as create an account with the system 10. This will allow a retailer to complete a matching process for all possible matching manufacturers/Attorney brands. According to various embodiments, prior to providing the information regarding its associated manufacturers, the dealer computing system 14 may first access the system 10 to search for matching manufacturers/brands with the manufacturers for which the dealer/retailer is an authorized dealer. The dealer computer system 14, which may include an e-commerce site enabled for product sales or an informational site, may host any number of web pages which include products which are offered for sale “online” or informational pages about the brands they carry. The dealer computing system 14 may receive application software (e.g., JavaScript) from the system 10 and install the application software on their product web pages. Various parameters may be coded into the application software for subsequent use by the system 10 to match authorized dealers to the product they have offered for sale. Such parameters may include, for example, the following variables: a URL associated with the retailer website, a URL associated with a product page, a retailer SKU, a brand, a manufacturer part number, style/model information, title information, a price, a retailer category, etc.

The aforementioned parameters may be sent by the retailer as part of the application software that resides on their web pages. The parameters may also be extracted by the system 10 if a retailer does not send them or cannot send them. A given retailer can send a plurality of values for every variable listed and it is certain that some values will not match up against those in the manufacturer's business rules. A retailer using the dealer computing system 14 can alias (translate an unmatched variables that is in fact a matching variable to the one the manufacturer entered) unmatched values they have sent to the system 10 or that the system 10 extracted. According to various embodiments, the system 10 may automatically retrieve the information regarding the variables from the dealer computing system 14.

Using the dealer computing system 14, a retailer will be able to view network statistics generated via the variables and values they have sent via the software application (e.g., javascript) on their web pages. Additionally, web logs resident on the system 10 and generated via the traffic to these pages will provide various data such as time visited, referring URL to the badge, operating system, browser, time spent on page, IP address, etc. The combination of both sets of data will generate relevant traffic statistics around the SKU, brand, retailer site, category, model, URL, etc. If a retailer installs an additional program (e.g., JavaScript or pixel) on their final checkout pages, additional statistics can provide for conversion statistics enabling them to evaluate improvements for badging implementations.

The consumer computer system 16 may include any suitable type of computing device. For example, according to various embodiments, the consumer computing system 16 may include one or more servers, desktops, laptops, tablets, smart phones, personal digital assistants, etc. which can be communicably connected to the network 18. The consumer computing system 16 is configured to access the web pages hosted and/or served by the dealer computing system 14, and to communicate with the system 10 via the network.

Each of the one or more networks 18 may include any type of delivery system including, but not limited to, a local area network (e.g., Ethernet), a wide area network (e.g. the Internet and/or World Wide Web), a telephone network (e.g., analog, digital, wired, wireless, fiber optic, PSTN, ISDN, GSM, GPRS, and/or xDSL), a packet-switched network, a radio network, a television network, a cable network, a satellite network, and/or any other wired or wireless communications network configured to carry data. A given network 16 may include elements, such as, for example, intermediate nodes, proxy servers, routers, switches, and adapters configured to direct and/or deliver data. In general, the system 10 may be structured and arranged to communicate with the computing systems 12, 14, 16 via the one or more networks 18 using various communication protocols (e.g., HTTP, HTTPS, TCP/IP, UDP, WAP, WiFi, Bluetooth) and/or to operate within or in concert with one or more other communications systems.

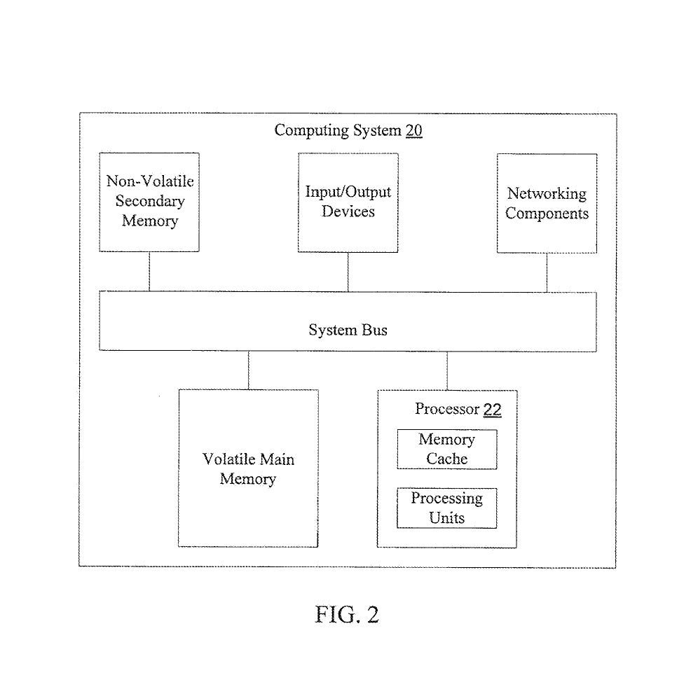

The system 10 includes a computing system 20. The computing system 20 may include any suitable type of computing device (e.g., a server, a desktop, a laptop, etc.) that includes at least one processor 22. Various embodiments of the computing system 20 are described in more detail hereinbelow with respect to FIG. 2.

FIG. 2 illustrates various embodiments of the computing system 20. The computing system 20 may be embodied as one or more computing devices, and includes networking components such as Ethernet adapters, non-volatile secondary memory such as magnetic disks, input/output devices such as keyboards and visual displays, volatile main memory, and a processor 22. Each of these components may be communicably connected via a common system bus. The processor 22 includes processing units and on-chip storage devices such as memory caches.

According to various embodiments, the computing system 20 includes one or more modules which are implemented in software, and the software is stored in non-volatile memory devices while not in use. When the software is needed, the software is loaded into volatile main memory. After the software is loaded into volatile main memory, the processor 20 reads software instructions from volatile main memory and performs useful operations by executing sequences of the software instructions on data which is read into the processor 22 from volatile main memory. Upon completion of the useful operations, the processor 22 writes certain data results to volatile main memory.

Returning to FIG. 1, according to various embodiments, the system 10 includes one or more of the following: a storage device 24, a verification module 26, a badging module 28 and a rules/content module 30. According to various embodiments, the system 10 also includes a variable extraction module 32.

The storage device 24 is communicably connected to the processor 22. As shown in FIG. 1, the storage device 24 may be integral with the computing system 20. According to other embodiments, the storage device 24 is remote from but communicably connected to the computing system 20. Information provided to the system 10 by (and/or received from) the manufacturer computing system 12, the dealer/retailer computing system 14 and the consumer computing system 16 may be organized into one or more databases residing at the storage device 24. The information in the one or more databases defines relationships between manufacturers and dealers/retailers, and the relationships may be defined all the way down to the retail product level or as high as a brand level. For example, the information in the one or more databases may include information about each product's/brand's manufacturer, distributors, retailers and retail customers. The information may also include business rules regarding product information such as warranty and support details, authorized distributors, retailers and their specific online and physical locations where they can sell the products and services. Additionally, as described in more detail hereinbelow, the storage device 24 may also hold badges/logos, endorsement information, and certificates/guarantees utilized by the system 10. Although only one storage device 24 is shown in FIG. 1, it will be appreciated that the system 10 may include any number of storage devices 24.

The verification module 26 is communicably connected to the processor 22 and is configured to determine whether a dealer/retailer associated with a product web page has an account with the system 10, and if so, whether the dealer/retailer is authorized by the manufacturer to sell the brand(s) of the product(s) being offered on the product web page. If the verification module 26 determines that the dealer/retailer does not have an account with the system 10 or is not authorized by the manufacturer to sell any of the brands of the products being offered on the product web page, the verification module 26 will not designate the dealer/retailer as an authorized dealer for the request being made by the consumer computing system 16. If the verification module 26 determines that the dealer/retailer has an account with the system 10 and is authorized by the manufacturer to sell one or more of the brands of the products being offered on the product web page, the verification module 26 may designate the dealer/retailer as an authorized dealer for the applicable brand(s). It will be appreciated that in some instances, the verification module 26 may determine that a dealer/retailer is an authorized dealer for one brand offered on a product web page but is not an authorized dealer for another brand offered on the product web page.

As described in more detail hereinafter, when a consumer accesses a product web page hosted and/or served by the dealer computing system 14, a “copy” of the product web page is sent to the consumer computing system 16 from the dealer/retailer computing system 14 hosting the e-commerce system or informational site. The product web page received by the consumer computing system 16 may include the application software (e.g. JavaScript) previously installed on the product web page at the dealer computer system 14 and served from the dealer/retailer computing system 14 hosting their e-commerce or informational site. When the application software is executed by the consumer computing system 16, the consumer computing system 16 transmits a verification request to the system 10, whereby the verification request includes one or more of the product/brand/service identification parameters previously coded into the application software at the dealer computing system 14. After the system 10 receives the verification request (including the parameters), the verification module 26 may compare the information included with the received verification request to the information in the one or more databases residing at the storage device 24 to make the above-described determinations.

According to various embodiments, the verification module 26 is further configured to compare the information included with the received verification request to the information in the one or more databases residing at the storage device 24 to verify that the dealer/retailer is authorized by the manufacturer to sell the individual product(s) being offered on the product web page. According to various embodiments, the verification module 26 may be yet further configured to compare the information included with the received verification request to the information in the one or more databases residing at the storage device 24 to determine whether any applicable discount, rebate, price and/or promotion period applies to a particular product on the product web page. It will be appreciated that the verification module 26 may be utilized to verify, for any number of product web pages, whether the dealer/retailer associated with the product web page has an account with the system 10, whether the dealer/retailer is authorized by the manufacturer to sell any of the brands of the products being offered on the product web page, whether the dealer/retailer is authorized by the manufacturer to sell any of the individual products being offered on the product web page, and whether any applicable discount, rebate, price and/or promotion period applies to a particular product on the product web page.

The badging module 28 is communicably connected to the processor 22 and is configured to transmit one or more badges/logos to the consumer computing system 16 as applicable. If the verification module 26 determines that the dealer/retailer associated with the product web page is not an authorized dealer, the badging module 28 will not transmit any badges/logos to the consumer computing system 16. If the verification module 26 determines that the dealer/retailer is an authorized dealer, the badging module 28 will transmit one or more badges/logos to the consumer computing system 16.

According to various embodiments, the badging module 28 is configured to generate a “master” badge/logo by inserting the name of the manufacturer (e.g., Canon, Sony, Olympus, Toshiba, etc.) into a predetermined template to complete the badge/logo. This may be done in cooperation with the manufacturer and/or the dealer/retailer as part of the account establishment process. The badging module 28 is also configured to thereafter access the “master” badges/logos, generate “copies” of the “master” badges/logos, assign identifiers (e.g., a unique serial number, a date, a time, etc.) to the respective “copies” of the badges/logos, then transmit the unique badges/logos to the consumer computing device 16. When the transmitted badge/logo is subsequently received by the consumer computing system 16, the consumer computing device 16 adds the badge/logo to the displayed product web page.

Each badge/logo is sent in a serialized fashion each time a consumer views a given product page. Thus, for a given product on a given product web page, it will be appreciated that a badge/logo sent to the consumer computing system 16 at a first time will not be “identical” to a badge/logo sent to the consumer computing system 16 at a second time. Although the two badges/logos sent to the consumer computing system at the two different times will appear to be the same, they are different instances where one will be more current than the other. For example, if a consumer “refreshes” a display screen of the consumer computing system 16, a different instance of the badge/logo will be transmitted by the badging module 28 to the consumer computing system 16.

According to various embodiments, the badging module 28 is also configured to transmit endorsements to the consumer computing system 16 as applicable. In general, such endorsements are approved by the manufacturer, may serve to reaffirm a consumer's confidence in the manufacturer/dealer relationship, and may include additional information about the dealer/retailer, the product, etc. According to various embodiments, the badging module 28 accesses a completed endorsement which was previously approved by the manufacturer as part of the account establishment process.

According to various embodiments, the endorsements may be transmitted to the consumer computing system 16 along with the badges for subsequent display by the badge or “over” the product web page displayed by the consumer computing system 16. In general, the endorsement will be displayed “over” the product web page in a manner so as to not block out the badge/logo and/or any of the associated product information (e.g., to the “left” or “right” of the badge/logo). For such embodiments, a consumer may use an input device (e.g., a mouse, a trackball, etc.) to “hover” over the badge/logo (or click a selection) on the product web page displayed by the consumer computing device 16 in order to show the endorsement. According to other embodiments, the endorsements may be transmitted to the consumer computing system 16 in response to a consumer using a pointing device to select/click a link provided on the displayed product web page.

The rules/content module 30 is communicably connected to the processor 22. According to various embodiments, the rules/content module 30 is configured to provide information for subsequent use in an endorsement such as a “flyout” or pop-up promotion. Such information may include promotional text, graphics, etc. According to various embodiments, the rules/content module 30 is configured to transmit a certificate to the consumer computing system 16 for subsequent display “over” the product web page displayed by the consumer computing system 16. For such embodiments, a consumer may use an input device (e.g., a mouse, a trackball, etc.) to click on or “hover” over the badge on the product web page (or click on or hover over an area of the product web page) displayed by the consumer computing device 16 in order to show the certificate. In general, the certificate will be displayed “over” the product web page in a manner so as to not block out the badge/logo and/or any of the associated product information. Of course, the retailer may configure the certificate to be displayed in a different manner. The certificate may be embodied in a plurality of different forms. For example, in one form, a certificate may include information indicating that the dealer/retailer is authorized by the manufacturer. In another form, the certificate may be embodied as a certificate indicating warranty information applicable to the given brand and/or product. In yet another form, the certificate may be embodied as a certificate indicating promotional information applicable to the given brand and/or product. In general, such certificates are approved by the manufacturer and/or the dealer/retailer, and may serve to reaffirm a consumer's confidence in the manufacturer, the dealer/retailer, the product, etc.

The variable extraction module 32 is communicably connected to the processor 22, and is configured to automatically retrieve information regarding the variables (e.g., a URL associated with the retailer website, a URL associated with a product page, a retailer SKU, a brand, a manufacturer part number, style/model information, title information, a price, a retailer category, etc.) associated with the manufacturer computer system 12 and/or the retailer computer system 14.

In certain instances, it may not be easy for a given manufacturer, dealer and/or retailer to provide the information regarding the variables to the system 10. For such instances, a targeting template may be utilized to manually identify one or more of the variables which are present on a given product web page hosted and/or served by the dealer computing system 14. The identified variables may be populated into fields of the targeting template, and the populated targeting template may be saved to the storage device 24. Application software (e.g. JavaScript) may be installed in the footer of the product web page so that when the product web page is rendered, the application software will “point” to the populated targeting template residing at the storage device 24. The variable extraction module 32 utilizes the “pointing” to automatically retrieve the variables associated with the product web page from the populated targeting template. According to other embodiments, the variable extraction module 32 is also configured to search the source code of the product web page and/or the document object model associated with the product web page to identify the variables.

The modules 26-32 may be communicably connected with one another, and may be implemented in hardware, firmware, software and combinations thereof. For embodiments utilizing software, the software may utilize any suitable computer language (e.g., C, C++, C#, Perl, Java, JavaScript, Visual Basic, VBScript, Delphi) and may be embodied permanently or temporarily in any type of machine, component, physical or virtual equipment, storage medium, or propagated signal capable of delivering instructions to a device. The modules 26-32 (e.g., software application, computer program) may be stored on a computer-readable medium (e.g., disk, device, and/or propagated signal) such that when a computer reads the medium, the functions described herein-above are performed. According to various embodiments, the above-described functionality of the modules 26-32 may be combined into fewer modules, distributed amongst additional modules, etc.

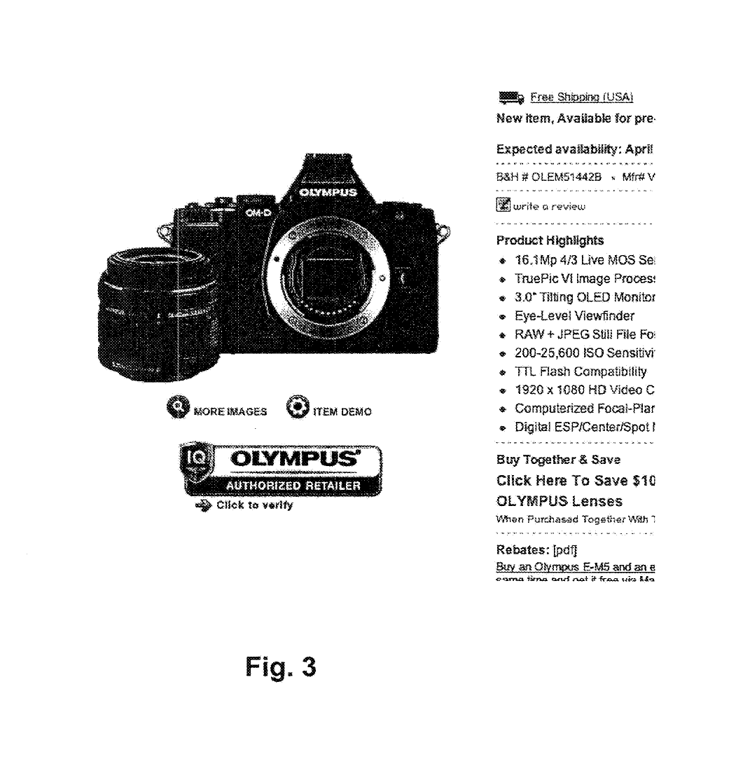

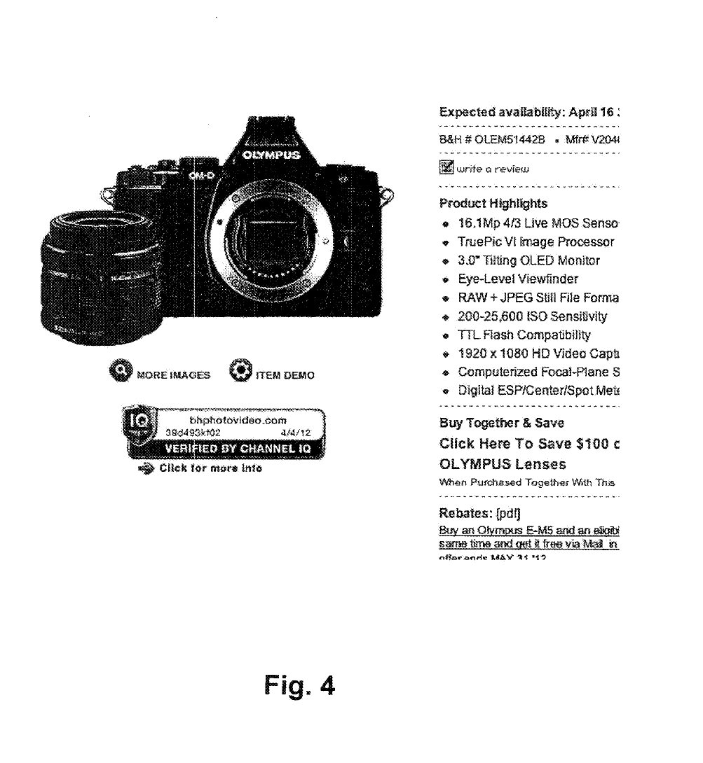

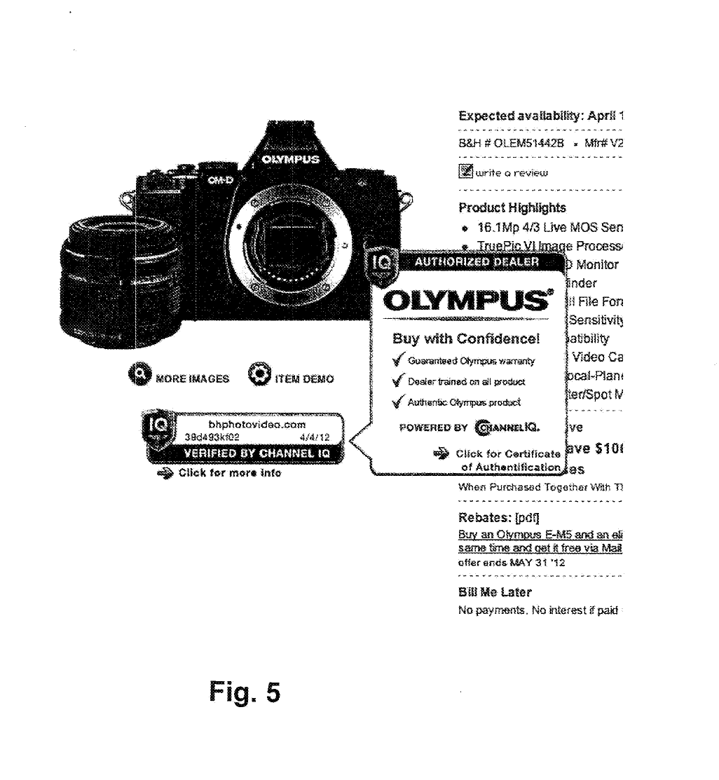

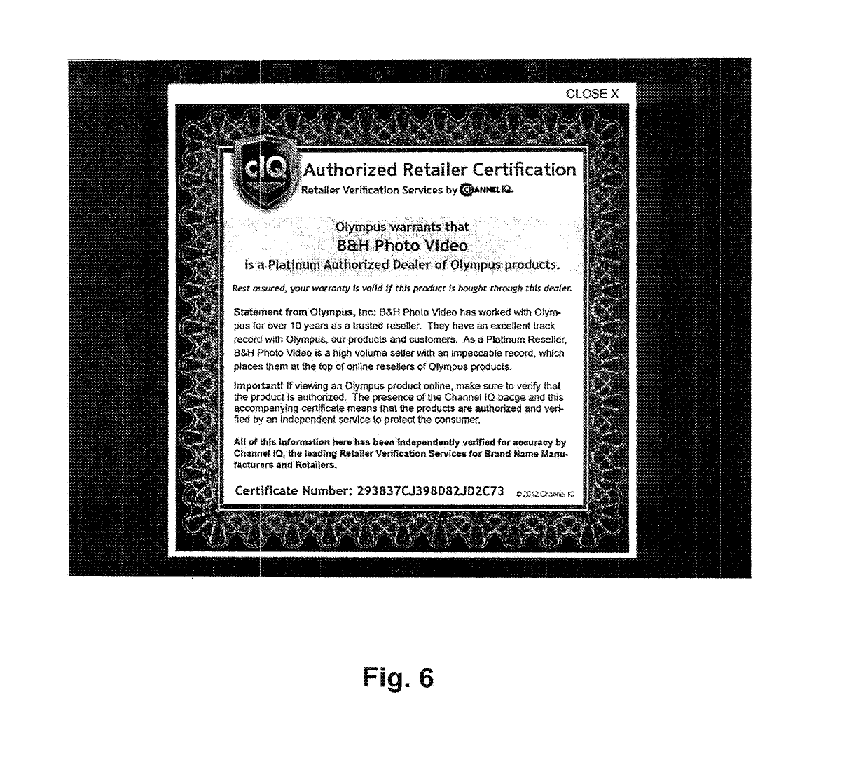

FIGS. 3-6 are exemplary screen shots of badges, endorsements and certificates provided by the system 10 for subsequent display by the consumer computing device 16. FIG. 3 is a screen shot from a retailer's website (B&H) which shows an Olympus camera being offered for sale. Below the image of the camera is the badge/logo which includes the name of the manufacturer (Olympus) and indicates that B&H is an authorized retailer. Hovering over or clicking on the “click to verify” link below the badge/logo can cause the information in the badge/logo to change to indicate, for example, the web address of the B&H website (bhphotovideo.com), a unique serial number (39d493kf02), a date (4/4/12) and that the authorized dealer status of B&H has been verified by ChannelIQ as shown in FIG. 4. Hovering over or clicking on the link “click for more info” shown below the badge/logo in FIG. 4 can cause the endorsement to appear to the right of the badge/logo as shown in FIG. 5. In FIG. 5, the endorsement includes the name of the manufacturer (Olympus), indicates that B&H is an authorized retailer, and includes additional information which can operate to reaffirm the consumer's confidence in the manufacturer/dealer relationship. Hovering over or clicking on the link “click for certificate of authentication” shown at the bottom of the endorsement can result in an “Authorized Retailer Certification” being displayed as shown in FIG. 6. As shown in FIG. 6, the certificate may include, among other things, a certificate number.

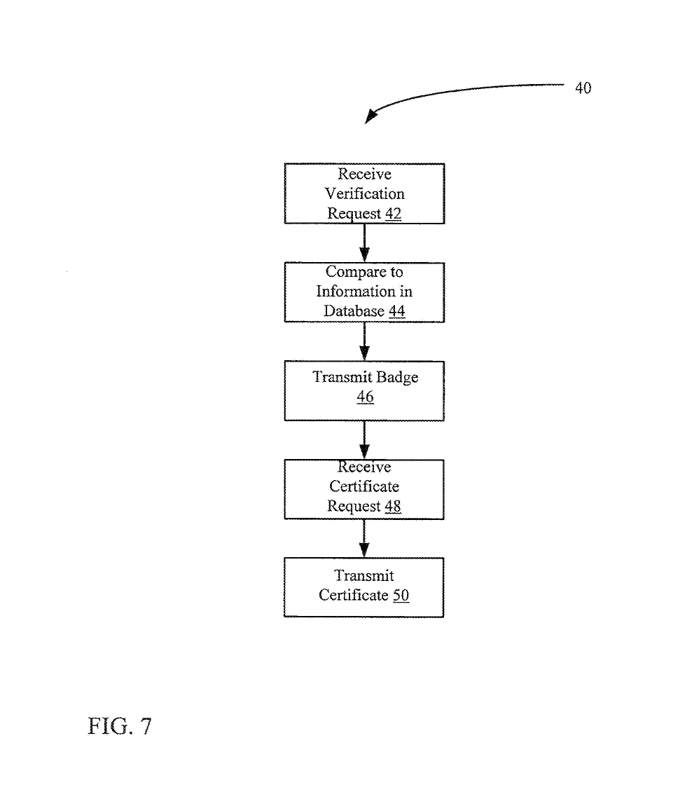

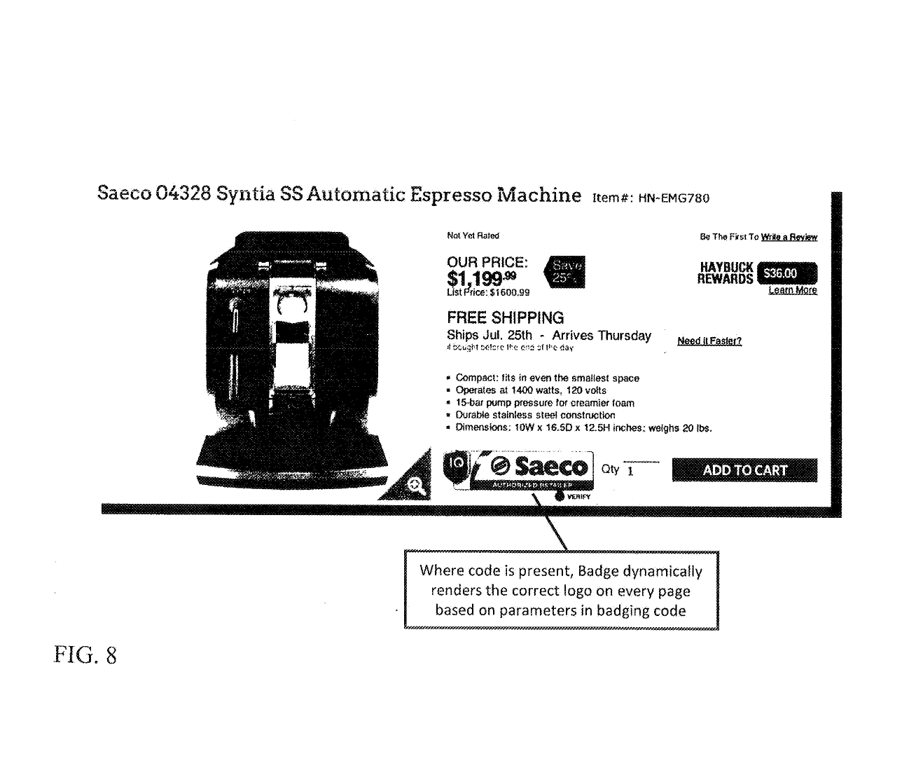

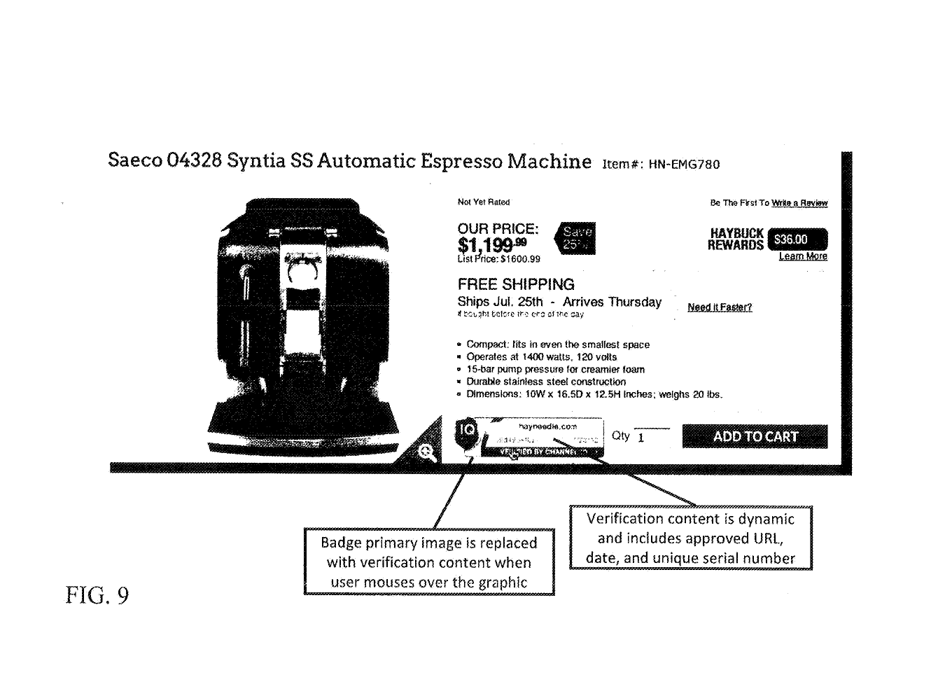

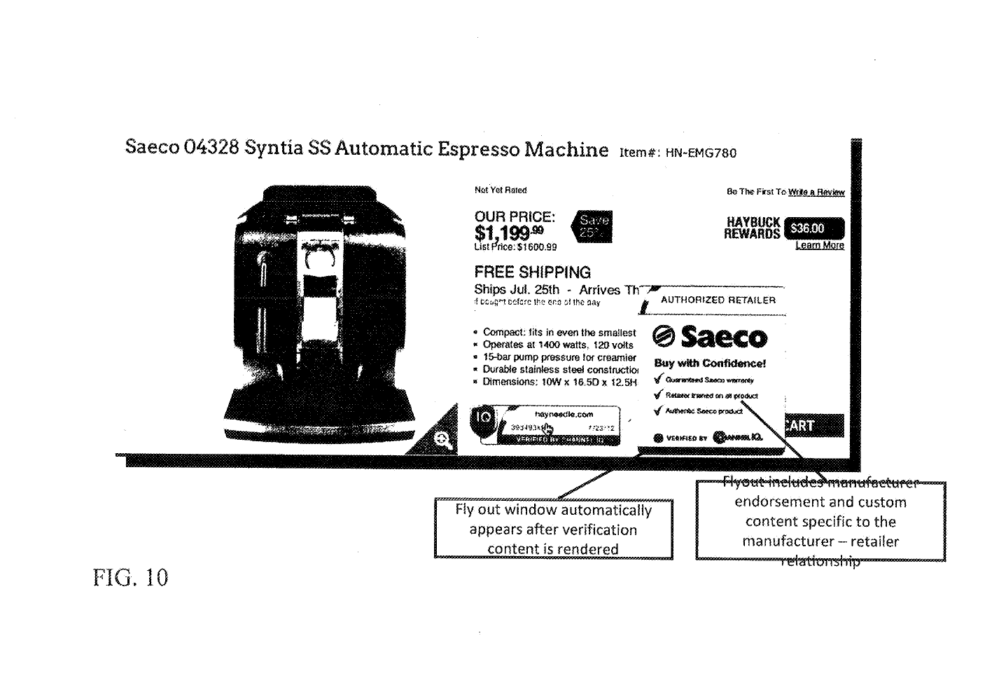

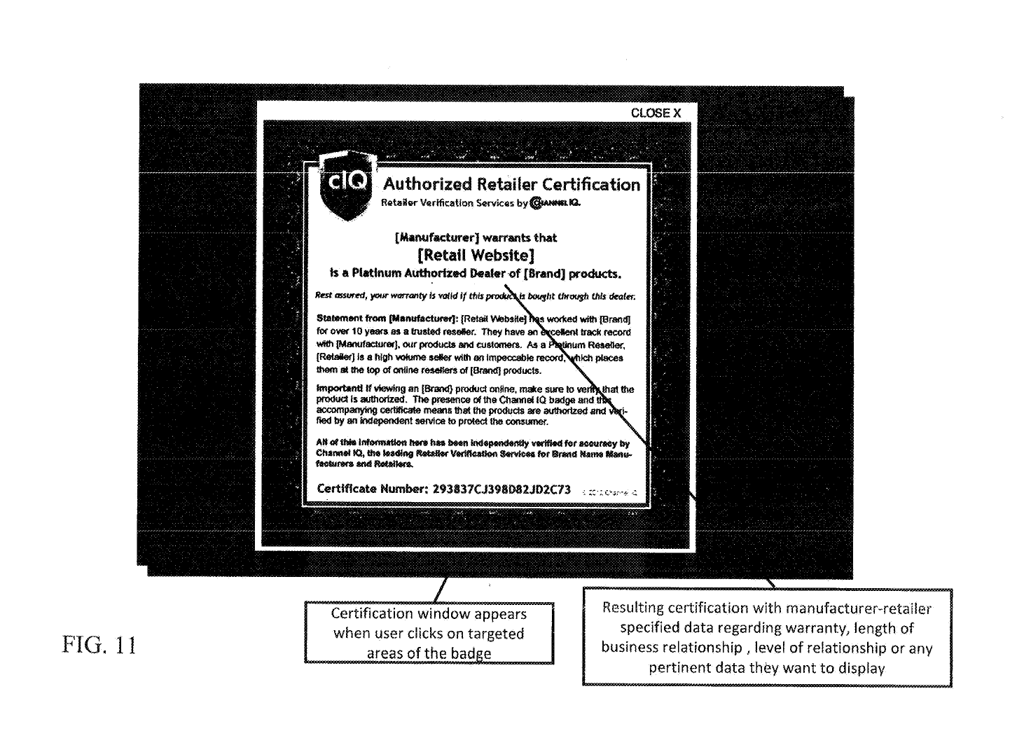

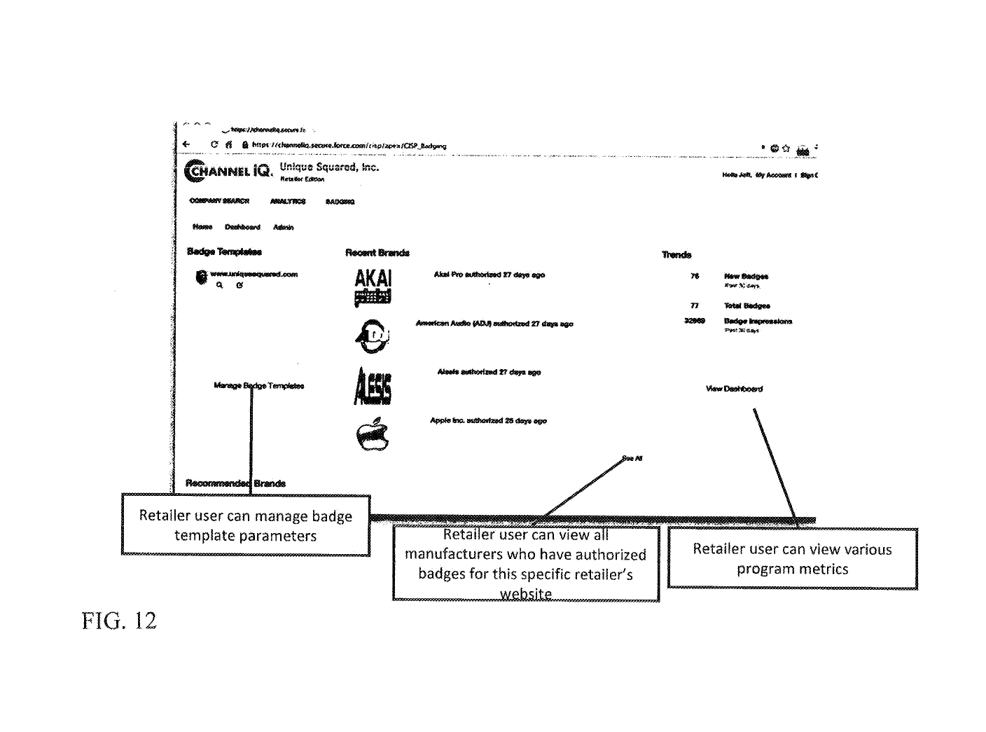

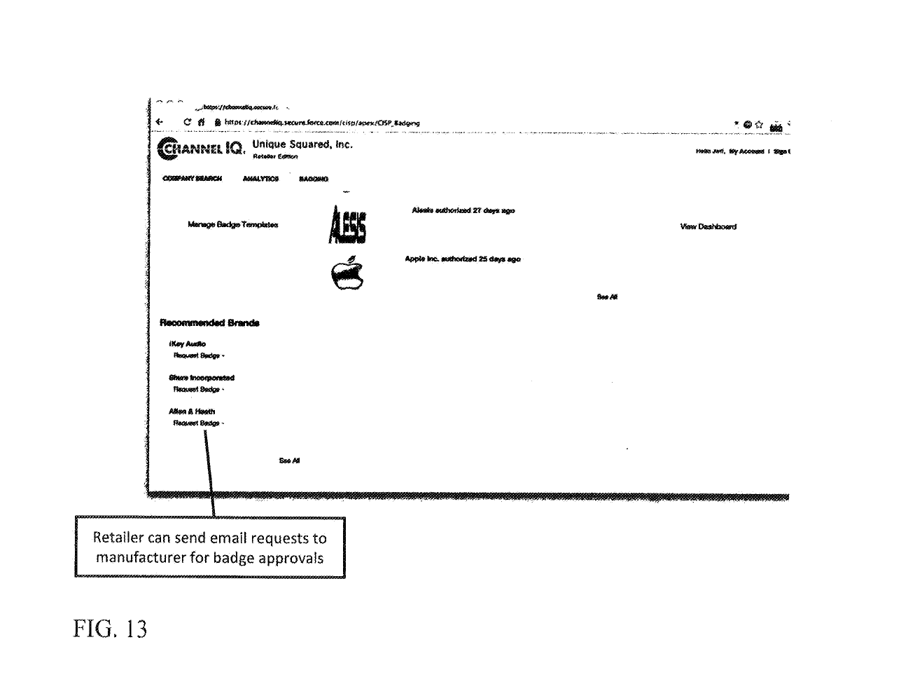

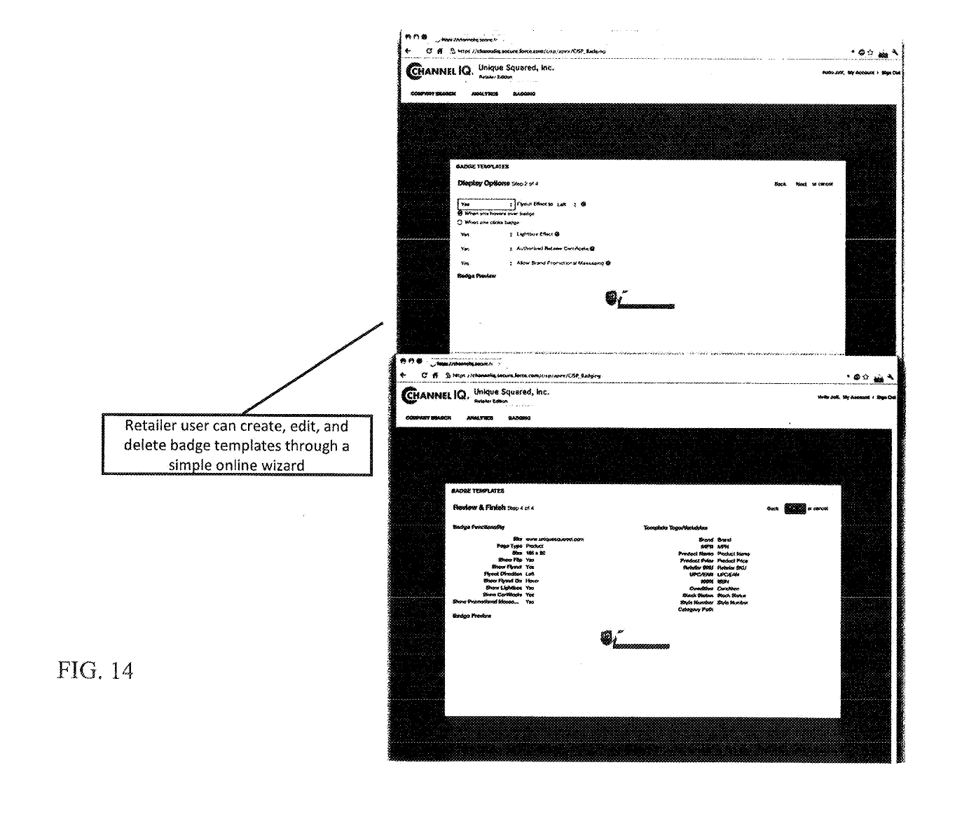

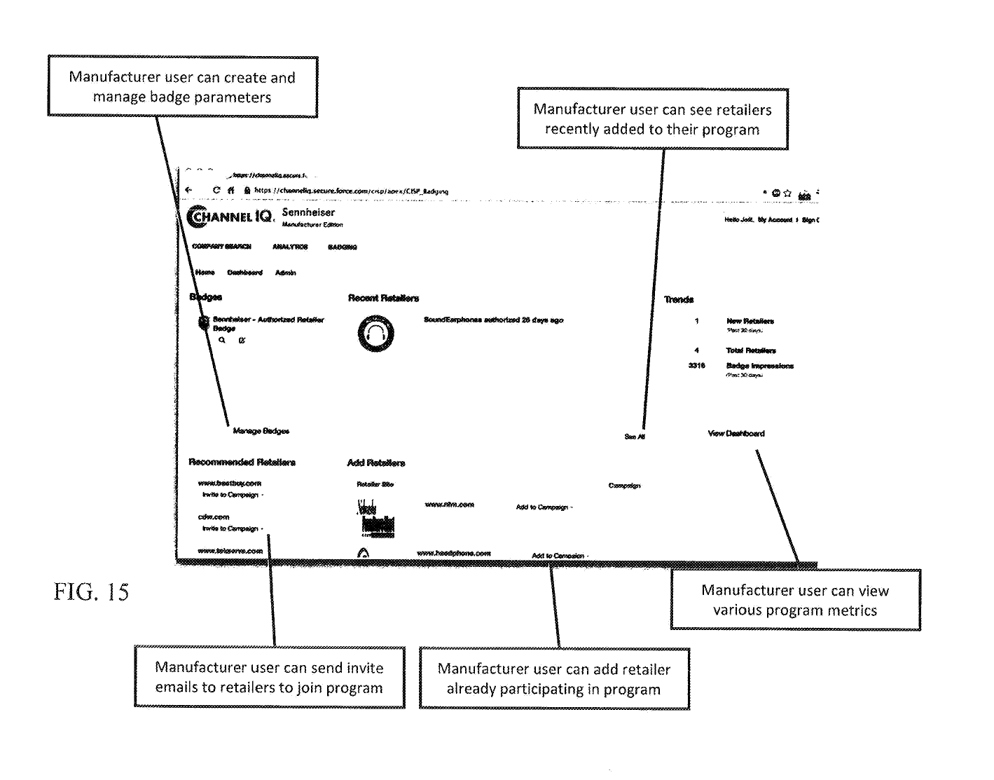

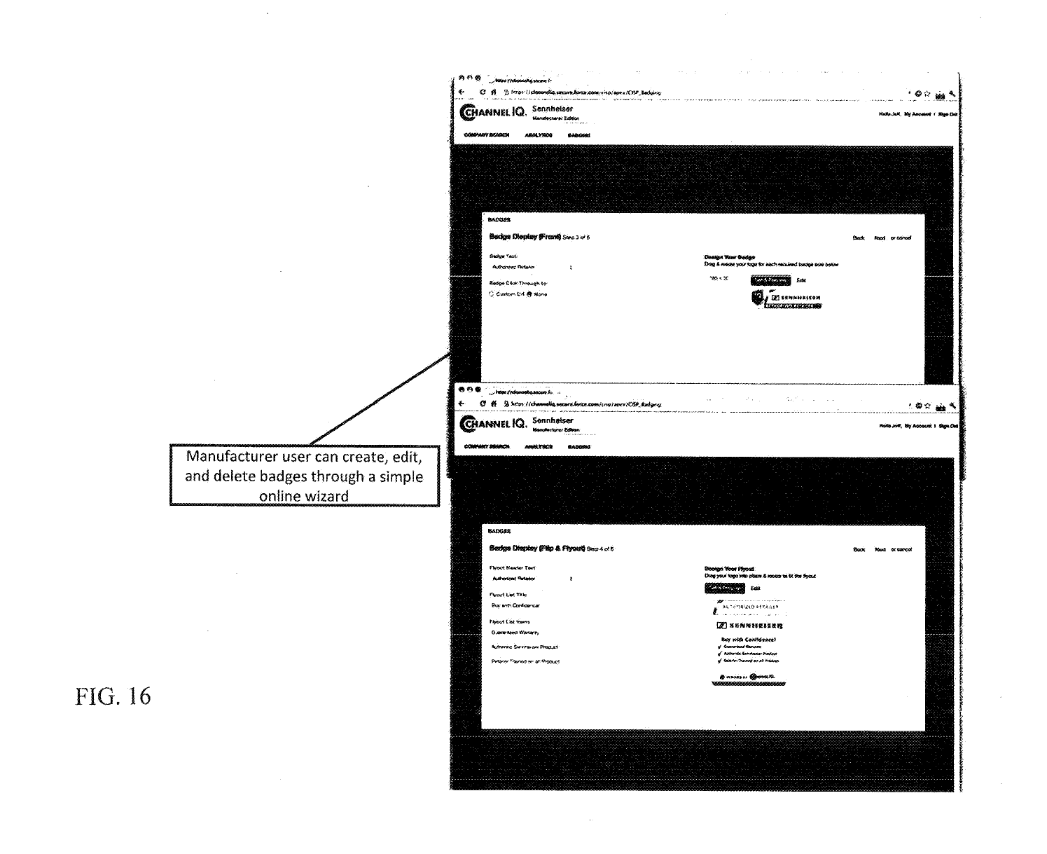

FIG. 7 illustrates various embodiments of a method 40 for providing verification of seller authorization and product authentication. According to various embodiments, the method 40 may be implemented by the system 10. For purposes of simplicity, the method 40 will be described in the context of being implemented by the system 10. However, it will be appreciated that the method 40 may be implemented by systems/devices other than the system 10.

Prior to the start of the process, accounts are established for various manufacturers and dealers/retailers, and information regarding the manufacturers, the products the manufacturers make, and the dealers/retailers that sell the products sell online may be received by the system 10. The received information is organized into one or more databases residing at the storage device 24. For a given manufacturer, such information may include, for example, a list of the manufacturer's products, warranty information for the respective products, stock-keeping unit (SKU) information for the respective products, lists of authorized sellers (e.g., dealers) for the respective products, the product brands the respective authorized sellers are authorized to sell, the specific products the authorized sellers are authorized to sell, the specific geographic regions the respective authorized sellers are authorized to sell in and/or ship sold products to, the date a given seller became authorized, etc. According to various embodiments, the manufacturer information may be provided to the system 10 by the manufacturer computing system 12 and the dealer/retailer information may be provided to the system 10 by the dealer/retailer computing system 14. According to other embodiments, the information may be received indirectly (e.g., via the mail), then input into the system 10 by a person having administrative rights regarding the system 10. It will be appreciated that information associated with additional manufacturers, the product they make, dealers/retailers and the products they sell may also be received by and/or input into the system 10 at any time during the process. Additionally, according to various embodiments, the third party providing the verification via the method 40 can independently input these rules by verifying information provided by manufacturers and retailers.

Also prior to the start of the process, application software (e.g., a JavaScript) is provided to the dealer/retailer computing system 14 for installation on product web pages of the dealer/retailer. According to various embodiments, the application software may be provided to the dealer/retailer computing system 14 by the system 10. According to other embodiments, the application software may be provided to the dealer/retailer system 14 indirectly (e.g., via a readable disk or device supplied by an owner of the system 10), then installed onto the product web pages of the dealer/retailer computing system 14 by a person having administrative rights regarding the dealer/retailer computing system 14. It will be appreciated that the application software may be provided to any number of dealers/retails for subsequent incorporation into their product web pages. Once the application software is installed on the product web pages of the dealer/retailer computing system 14, the dealer/retailer may code various parameters into the application software for subsequent use by the system 10 to match authorized dealers and products. Such parameters may include, for example, the following variables: a uniform resource locator (URL) associated with the retailer website, a URL associated with a product page, a retailer SKU, a brand, a manufacturer part number, style/model information, title information, a price, a retailer category, etc. As described hereinabove, according to various embodiments, the variable extraction module 32 may be utilized to automatically retrieve the variables associated with the product web page from the populated targeting template residing at the storage device 24. It will be appreciated that for such embodiments, the method 40 includes the retrieval of the variables by the variable extraction module 32.

Also prior to the start of the process, a consumer utilizes the consumer computing system 16 (or any computing system communicably connected to the network 18) to request a web page from the dealer computing system 14, where the web page includes one or more products offered for sale (e.g., a product web page) as well as the above-described application software. A browser of the consumer computing system 16 receives a “copy” of the web page and formats the content of the web page for display on a display device of the consumer computing system 16. Before the web page is completely rendered, the application software is executed by a processor of the consumer computing system 16, and the execution causes the consumer computing system 16 to transmit a verification request (e.g., a web service call) to the system 10. The verification request includes one or more of the parameters previously coded into the application software at the dealer computing system 14. For embodiments which utilize the variable extraction module 32 and the populated targeting templates to retrieve the information regarding the variables, before the web page is completely rendered, the application software (e.g., JavaScript) “calls” the variable extraction module 32 to provide the variables included in the populated targeting template associated with the product web page.

The process starts at block 42, where the system 10 receives the verification request transmitted by the consumer computing system 16. From block 42, the process advances to block 44, where the verification module 26 compares the information included in the verification request (as well as any information provided by the variable extraction module 32) to information included in the one or more databases residing at the storage device 24. Based on this comparison, the verification module determines whether the dealer/retailer has an account with the system 10, and if so, whether the dealer/retailer is authorized by the manufacturer to sell one or more of the brands of the products being offered on the product web page. If the verification module 26 determines that the dealer/retailer does not have an account with the system 10 or is not authorized by the manufacturer to sell one or more of the brands of the products being offered on the product web page, the process ends with no execution of a badge being rendered on the product page at the consumer's computing system 16. However, if the verification module 26 determines that the dealer/retailer does have an account with the system 10 and is authorized by the manufacturer to sell one or more of the brands of the products being offered on the product web page, the process advances from block 44 to block 46.

At block 46, the badging module 28 transmits one or more badges/logos to the consumer computing system 16 for subsequent display on the product web page. According to various embodiments, “masters” of the badges/logos are previously generated by the system 10 at the direction of individual manufacturers via the manufacturer computing systems 14. For such embodiments, the badging module 28 accesses a given master badge/logo, assigns a unique identifier (e.g., a unique serial number) to a “copy” of the given badge/logo, assigns the date of certification, labels the retailer's website URL, and then transmits the unique “copy” of the given badge/logo/information to the consumer computing system 16 for subsequent display on the product web page. According to various embodiments, the badging module 28 may also transmit one or more endorsements with the badges/logos to the consumer computing system 16 for subsequent display. As set forth hereinabove, an endorsement may be displayed “over” the product web page responsive to a consumer utilizing a pointing device (e.g., a mouse, a trackball, etc.) to “hover” over or around or select/click a particular portion of a displayed product web page.

From block 46, the process advances to block 48, where the system 10 receives a request to provide a certificate associated with either the dealer/retailer, a brand, or a product on the product web page. Such a request may be generated, for example, by a consumer utilizing a pointing device (e.g., a mouse, a trackball, etc.) to select/click a link included on the displayed product web page. By selecting/clicking on the link, the consumer computing system 16 initiates a web service call to the system 10, where the web serve call is a request to provide the certificate associated with the link. As set forth hereinabove, the certificate may be embodied as a certificate indicating that the dealer/retailer is authorized by the manufacturer, as a certificate indicating warranty information applicable to the given brand and/or product, as a certificate indicating promotional information applicable to the given brand and/or product, etc.

From block 48, the process advances to block 50, where the rules/content module 30 transmits a certificate associated with the link to the consumer computing system 16 for subsequent display “over” the product web page. According to various embodiments, a “master” certificate associated with the link is stored at storage device 24. The rules/content module 30 accesses the “master” certificate associated with the link and stored at storage device 24, makes a “copy” of the certificate, then transmits the copy of the certificate to the consumer computing system 16 along with retailer/manufacturer specific relationship content to be rendered inline with the certificate graphics. The rules/content module 30 may transmit any number of certificates to any number of consumer computing systems 16. Since some of the information subsequently presented in the rendered badges, endorsements and certificates resides at the rules/content module 30, it will be appreciated that the rules/content module 30 may be accessed in a plurality of the above-described steps.

The system 10 completes the actions taken at blocks 42-50 (as well as the retrieval of the variable information from the targeting template) in real-time or in near real-time (e.g., on the order of milliseconds up to hundreds of milliseconds). Accordingly, even though the badges/logos are dynamically provided by the system 10, the actual insertion of the badges/logos into a given product web page displayed by the consumer computing device 16 appears to a consumer as if the badges/logos are simply a part of the product web page. In view of the foregoing, it will be appreciated that the system 10 and method 40 may be utilized to dynamically provide a badge/logo for any brand or product included on any product web page at any time.

Nothing in the above description is meant to limit the invention to any specific materials, geometry, or orientation of elements. Many part/orientation substitutions are contemplated within the scope of the invention and will be apparent to those skilled in the art. The embodiments described herein were presented by way of example only and should not be used to limit the scope of the invention.

Although the invention has been described in terms of particular embodiments in this application, one of ordinary skill in the art, in light of the teachings herein, can generate additional embodiments and modifications without departing from the spirit of, or exceeding the scope of, the claimed invention. For example, according to various embodiments, the actions taken at blocks 42-50 may be taking place for any number of different product web pages. Thus, the action taking place at one block for one product web page may be taking place concurrently with the action taking place at another block for another product web page. Accordingly, it is understood that the drawings and the descriptions herein are proffered only to facilitate comprehension of the invention and should not be construed to limit the scope thereof.

What is claimed is:

1. A system providing verification of seller authorization and product authentication, the system comprising:
a computing device, wherein the computing device comprises a processor;
a verification module communicably connected to the processor, wherein the verification module is configured to determine if:
a seller has an account with the system; and
the seller is authorized by a manufacturer to sell a product manufactured by the manufacturer and being offered for sale on a product web page; and
a badging module communicably connected to the processor, wherein the badging module is configured to generate a badge if:
the seller has an account with the system; and
the seller is authorized by the manufacturer to sell the product.

2. The system of claim 1, wherein the verification module is further configured to designate the seller as an authorized seller of the product.

3. The system of claim 1, wherein the verification module is further configured to determine if the seller is authorized to sell a brand of products being offered for sale on the product web page.

4. The system of claim 1, wherein the verification module is further configured to determine if any of the following applies to the product:
a discount;
a rebate; and
a promotion period.

5. The system of claim 1, wherein the badging module is further configured to transmit the generated badge.

6. The system of claim 1, wherein the badging module is further configured to transmit an endorsement.

7. The system of claim 1, further comprising a rules/content module communicably connected to the processor, wherein the rules/content module is configured to provide information for an endorsement.

8. The system of claim 1, further comprising a rules/content module communicably connected to the processor, wherein the rules/content module is configured to transmit a certificate.

9. The system of claim 1, further comprising a variable extraction module communicably connected to the processor, wherein the variable extraction module is configured to automatically retrieve information regarding one or more variables associated with the product web page.

10. The system of claim 1, further comprising a variable extraction module communicably connected to the processor, wherein the variable extraction module is configured to provide information regarding one or more variables associated with the product web page to the verification module.

11. A method, implemented at least in part by a computing device, for providing verification of seller authorization and product authentication, the method comprising:
determining if a seller is authorized by a manufacturer to sell a product manufactured by the manufacturer and being offered for sale on a product web page, wherein the determining is performed by the computing device;
generating a badge if the seller is authorized by the manufacturer to sell the product, wherein the generating is performed by the computing device; and
transmitting the badge, wherein the transmitting is performed by the computing device.

12. The method of claim 11, wherein determining if the seller is authorized comprises determining if the seller has a user account with a verification service provider.

13. The method of claim 11, wherein determining if the seller is authorized comprises comparing information included in a received verification request with stored information.

14. The method of claim 11, wherein generating the badge comprises:
accessing a master badge;
generating a copy of the master badge;
assigning a unique identifier to the copy of the master badge;
assigning a date of certification for the copy of the master badge.

15. The method of claim 14, further comprising labeling a uniform resource locator associated with the product web page.

16. The method of claim 11, further comprising transmitting an endorsement.

17. The method of claim 11, further comprising:
generating a certificate; and
transmitting the generated certificate.

18. The method of claim 17, wherein generating the certificate comprises:
accessing a master certificate; and
generating a copy of the master certificate.

19. The method of claim 11, further comprising automatically retrieving information regarding variables associated with the product web page.

20. The method of claim 19, wherein automatically retrieving information regarding variables comprises automatically retrieving one or more of the following:
a uniform resource locator associated with a website;
a uniform resource locator associated with the product web page;
a stock-keeping unit of the product;
a brand associated with the product;
a manufacturer part number of the product;
style/model information for the product;
title information for the product;
a price of the product; and
a retailer category associated with the product.
